(19) United States
(12) Patent Application Publication
(10) Pub. No.: US 2025/0282434 A1
(43) Pub. Date: Sep. 11, 2025

(54) HUB LOCK AND PERSONAL MOBILITY VEHICLE

(71) Applicant: Ninebot (Shenzhen) Tech Co., Ltd., Shenzhen (CN)

(72) Inventors: Yi Lou, Shenzhen (CN); Yubao Xie, Shenzhen (CN); Youtong Lin, Shenzhen (CN)

(21) Appl. No.: 19/068,362

(22) Filed: Mar. 3, 2025

(30) Foreign Application Priority Data
Mar. 5, 2024 (CN) 202420430427.4

(51) Int. Cl. B62H 5/14; B60B 27/00

(52) U.S. Cl. CPC B62H 5/148; B60B 27/0015; B60B 27/0052; B62H 5/141

(57) ABSTRACT

A hub lock includes a lock body fixedly mounted on a rear fork and a lock disc connected to the hub, the lock body includes a lock pin movable in a first direction between first and second critical positions, the lock disc has a lock slot and a guiding face capable of opposing the lock pin in the first direction, the lock pin is fitted in the lock slot at the first critical position, the lock pin is slidingly fitted to the guiding face during a movement from the second critical position towards the first critical position, the lock slot has first and second limiting faces opposite each other along a circumferential direction of the hub and both connected to the guiding face, a size of the first limiting face is greater than a size of the second limiting face in a depth direction of the lock slot.

### CROSS-REFERENCE TO RELATED APPLICATION

The present application claims the benefit of priority to Chinese Application No. 2024204304274, filed on Mar. 5, 2024, the content of which is incorporated herein by reference in its entirety for all purposes.

### FIELD

The present disclosure relates to the field of vehicle locks, and more particularly to a hub lock and a personal mobility vehicle.

### BACKGROUND

In the related art, the electric vehicles are usually installed with a hub lock on a rear wheel in order to improve the anti-theft function, and some of the hub locks use a lock pin to be inserted into a lock slot on the rear wheel assembly in order to realize the locking of the rear wheel. However, the lock pin type of hub locks has a risk of sharp stop of the rear wheel by accidentally ejecting and inserting the lock pin into the lock slot on the rear wheel assembly in a driving process of the electric vehicles, and when traveling at a high speed, the sharp stop of the rear wheel is very easy to cause the electric vehicle to roll over, seriously affecting the driver's driving safety.

### SUMMARY

In a first aspect, embodiments of the present disclosure provide a hub lock, and the hub lock includes a lock body and a lock disc. The lock body is fixedly mounted to a rear fork and including a lock pin movable in a first direction, the lock pin has a first critical position and a second critical position. The lock disc is connected to a hub, the lock disc is provided with a lock slot and a guiding face capable of opposing the lock pin in the first direction, the lock pin is fitted in the lock slot at the first critical position, the lock pin is slidingly fitted to the guiding face during a movement from the second critical position towards the first critical position, the lock slot has a first limiting face and a second limiting face opposite each other along a circumferential direction of the hub, the first limiting face and the second limiting face are both joined to the guiding face, a size of the first limiting face in a depth direction of the lock slot is greater than a size of the second limiting face in the depth direction of the lock slot.

In a second aspect, embodiments of the present disclosure provide a personal mobility vehicle, and the personal mobility vehicle includes a hub lock. The hub lock includes a lock body and a lock disc. The lock body is fixedly mounted to a rear fork and including a lock pin movable in a first direction, the lock pin has a first critical position and a second critical position. The lock disc is connected to a hub, the lock disc is provided with a lock slot and a guiding face capable of opposing the lock pin in the first direction, the lock pin is fitted in the lock slot at the first critical position, the lock pin is slidingly fitted to the guiding face during a movement from the second critical position towards the first critical position, the lock slot has a first limiting face and a second limiting face opposite each other along a circumferential direction of the hub, the first limiting face and the second limiting face are both joined to the guiding face, a size of the first limiting face in a depth direction of the lock slot is greater than a size of the second limiting face in the depth direction of the lock slot.

### BRIEF DESCRIPTION OF THE DRAWINGS

FIG. 1 is a schematic diagram of a hub lock according to an embodiment of the present disclosure, with a lock pin located in a first critical position.

FIG. 2 is a schematic diagram of a hub lock according to an embodiment of the present disclosure, with a lock pin located in a second critical position.

FIG. 3 is a schematic diagram of a hub lock according to an embodiment of the present disclosure, with a lock pin located between the first critical position and the second critical position and opposite to a lock slot.

FIG. 4 is another schematic diagram of a hub lock according to an embodiment of the present disclosure, with a lock pin located between the first critical position and the second critical position and abutting against the guiding sub-face.

FIG. 5 is a schematic diagram of a personal mobility vehicle according to an embodiment of the present disclosure.

FIG. 6 is a schematic block diagram of a personal mobility vehicle according to an embodiment of the present disclosure.

### BRIEF DESCRIPTION OF THE DRAWINGS

Embodiments of the present disclosure will be described in detail below, and examples of the embodiments are shown in accompanying drawings. The embodiments described herein with reference to drawings are explanatory, illustrative, and used to generally understand the present disclosure. The embodiments shall not be construed to limit the present application.

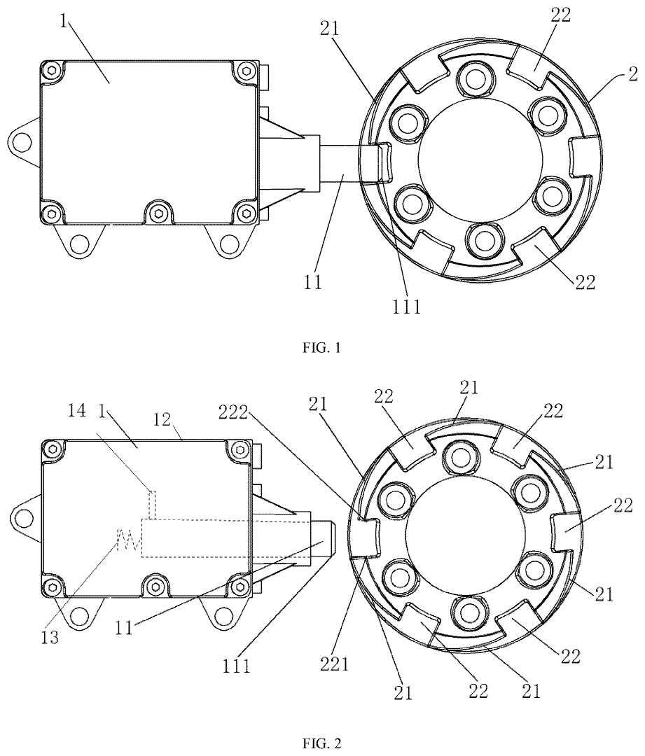

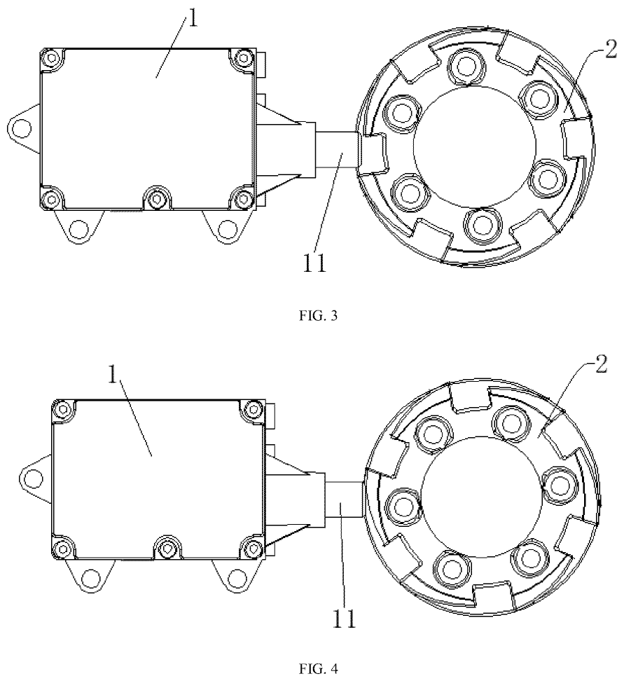

A hub lock according to embodiments of the present disclosure will be described below with reference to FIGS. 1 to 6.

The hub lock according to embodiments of the present disclosure includes a lock body 1 and a lock disc 2. The lock body 1 is fixedly mounted to a rear fork 3 and includes a lock pin 11 movable in a first direction, and the lock pin 11 has a first critical position and a second critical position. The lock disc 2 is connected to a hub 4, the lock disc 2 is provided with a lock slot 22 and a guiding face capable of opposing the lock pin 11 in the first direction. The lock pin 11 is fitted in the lock slot 22 at the first critical position, and the lock pin 11 is slidingly fitted to the guiding face during a movement from the second critical position towards the first critical position. The lock slot 22 has a first limiting face 221 and a second limiting face 222 opposite to each other along a circumferential direction of the hub 4, the first limiting face 221 and the second limiting face 222 are both joined to the guiding face, and a size of the first limiting face 221 in a depth direction of the lock slot 22 is greater than a size of the second limiting face 222 in the depth direction of the lock slot 22.

It could be understood that at the second critical positon, the lock pin 11 is retracted to the lock body 1, and disengaged from the lock disc 2, as illustrated in FIG. 2.

According to the hub lock of embodiments of the present disclosure, the lock body 1 and the lock disc 2 are mounted on the rear fork 3 and the hub 4, respectively, and as the hub 4 rotates, the lock slot 22 on the lock disc 2 rotates to oppose the lock pin 11, the lock pin 11 can move to the first critical position to fit in the lock slot 22, and the relative fixation of the rear fork 3 and the hub 4 in the circumferential direction of the hub 4 is realized under the limitation of the first limiting face 221 and the second limiting face 222 of the lock slot 22, i.e., realizing the locking function. The lock pin 11 is accidentally ejected from the second critical position and moves towards the first critical position, the lock pin 11 is more likely to abut against the guiding face and slidingly fit to the guiding face, and during this fitting, and there is no circumferential limitation on the hub 4.

In addition, the first limiting face 221 of the lock slot 22 is arranged to approach the lock pin 11 earlier relative to the second limiting face 222 when the hub 4 rotates at a high speed, and then the size of the first limiting face 221 in the depth direction of the lock slot 22 is arranged to be larger than the size of the second limiting face 222 in the depth direction of the lock slot 22, so that when the lock slot 22 is opposite to the lock pin 11, the lock pin 11 can easily pass through the lock slot 22 and continue to be slidingly fitted to the guiding face before it comes into contact with an outer edge of the second limiting face 222, which effectively reduces the risk of sharp stop of the rear wheel by inserting accidentally ejected lock pin 11 into the lock slot 22, and makes the driving safety of the driver higher.

It should be noted that a value of a difference between the size of the first limiting face 221 in the depth direction of the lock slot 22 and the size of the second limiting face 222 in the depth direction of the lock slot 22, time required for the ejected lock pin 11 to move the distance of the above value, and a distance between the first limiting face 221 and the second limiting face 222 of the lock slot 22 can be flexibly designed, to ensure that when the hub 4 rotates above a set speed, the accidentally ejected lock pin 11 will not insert into the lock slot 22, further ensuring the driving safety of the driver.

In some embodiments, as illustrated in FIGS. 1 to 6, a plurality of lock slots 22 are provided and arranged at intervals along the circumferential direction of the hub 4, the guiding face includes a plurality of guiding sub-faces 21, and the plurality of lock slots 22 and the plurality of guiding sub-faces 21 are arranged alternately along the circumferential direction of the hub 4. The first limiting face 221 and the second limiting face 222 of any lock slot 22 are both arranged at intervals in one direction, e.g., both arranged at intervals in a counterclockwise direction or both arranged at intervals in a clockwise direction.

At this time, when the vehicle needs to be locked, it is only necessary to rotate the rear wheel so that any of the lock slot 22 is opposite to the lock pin 11, that is, the lock pin 11 can be inserted into the lock slot 22, making the locking operation convenient and quick. Moreover, each guiding sub-face 21 can ensure a sliding fit with the lock pin 11 without limiting the lock pin, and at the same time, when the lock pin 11 slides relative to the guiding sub-face 21, the guiding sub-face 21 also push back the lock pin 11, causing the lock pin 11 to move towards the second critical position.

Specifically, for example, the first limiting face 221 and the second limiting face 222 of the lock slot 22 are arranged in a clockwise direction, during driving of the personal mobility vehicle, the hub 4 and the lock disc 2 are rotated in a counterclockwise direction to facilitate that the lock pin 11 passes through the outer edge of the first limiting face 221 first. Additionally, as illustrated in FIG. 2, preferably, the plurality of lock slots 22 are arranged at equal intervals along the circumferential direction of the hub 4, any one of the guiding sub-face 21 has the same shape and has two ends joined to different first limiting face 221 and second limiting face 222, respectively.

In some embodiments, as illustrated in FIGS. 1 and 2, any guiding sub-face 21 has a first end and a second end opposite each other along the circumferential direction of the hub 4, the first end face of the guiding sub-face 21 is joined to the first limiting face 221 on the lock slot 22, and the second end face of the guiding sub-face 21 is joined to the second limiting face 222 on the lock slot 22. A distance between any position of the guiding sub-face 21 from the first end to the second end of the guiding sub-face 21 and a central axis of the hub 4 decreases gradually. In each lock slot 22, the first limiting face 221 is joined to the first end face of the guiding sub-face 21, and the second limiting face 222 is joined to the second face of another sub-face 21.

That is, the second end of the guiding sub-face 21 is closer to the central axis of the hub 4. In this case, when the lock pin 11 slides relative to the guiding sub-face 21, the guiding sub-face 21 always pushes the lock pin 11 towards the second critical position, and a total distance pushed is the difference between the size of the first limiting face 221 in the depth direction of the lock slot 22 and the size of the second limiting face 222 in the depth direction of the lock slot 22. The arrangement keeps the lock pin 11 from moving too fast towards the second critical position and causing it to jump, and effectively reduce the risk of the lock pin 11 being spring back and jumping into the lock slot 22.

In some embodiments, as illustrated in FIGS. 1 and 2, the guiding sub-face 21 is a gradient surface curved towards the lock pin 11. The arrangement enables the lock pin 11 to moves more smoothly towards the second critical position during sliding relative to the guiding sub-face 21, and also avoids excessive sharpness as the intersections of the guiding sub-face 21 with the first limiting face 221 and the second limiting face 222 compared to a flat guiding sub-face 21, further improving the structural strength of the intersections.

In some embodiments, as illustrated in FIGS. 1 to 6, the lock pin 11 is located at a side of the lock disc 2 along a radial direction of the hub 4, the lock slot 22 is defined in an outer circumferential face of the lock disc 2, and at least a part of the outer circumferential face of the lock disc 2 forms the guiding sub-face 21.

In this case, the lock body 1 and the lock disc 2 may be arranged along a length direction of the personal mobility vehicle instead of along the width direction of the personal mobility vehicle, which reduces the difficulty of mounting the lock body 1 on the rear fork 3, and does not cause the personal mobility vehicle to be oversized in the width direction to the detriment of the aesthetics of the appearance.

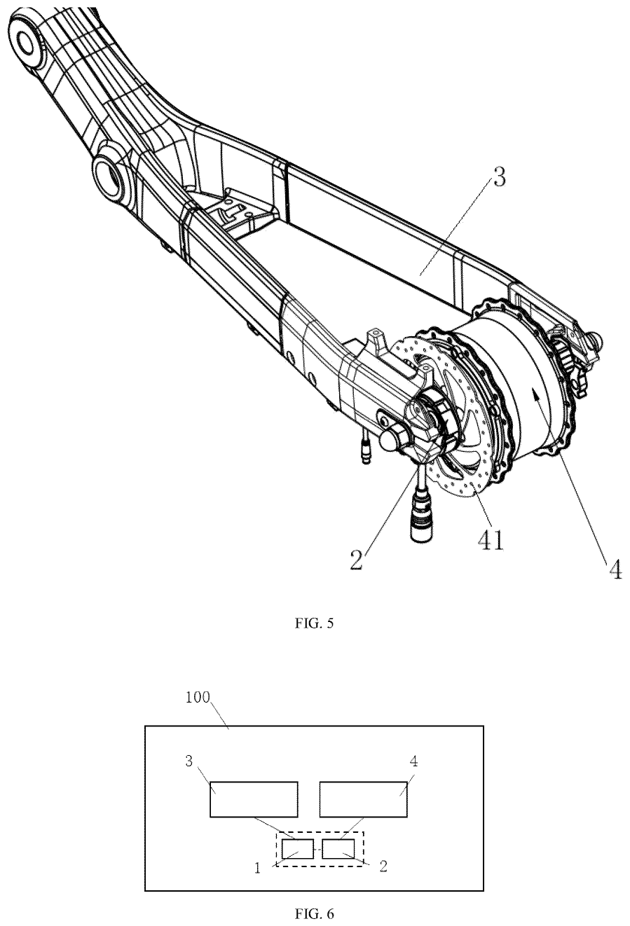

As illustrated in FIG. 5, the lock body 1 is mounted at an inner side of the rear fork 3, and substantially located at a side of the lock disc 2 towards a frame of the personal mobility vehicle.

In some embodiments, as illustrated in FIG. 5, the lock slot 22 extends through the lock disc 2 along an axial direction of the hub 4.

That is, the lock slot 22 is a U-shaped slot, and the lock disc 2 does not limit the lock pin 11 in the axial direction of the hub 4. In this case, during a movement of the lock pin 11 from the second critical position towards the first critical position, even if the lock pin 11 wobbles in the axial direction of the hub 4, there is no interference between the lock pin 11 and the lock disc 2 which prevents the lock pin 11 from being inserted into the lock slot 22, thus locking the vehicle is easier and faster.

In some embodiments, as illustrated in FIGS. 1 to 6, a chamfer 111 is provided at a junction of an outer circumferential face and a free end face of the lock pin 11.

Due to the design of the chamfer 111, when the lock pin 11 is accidentally ejected during traveling of the personal mobility vehicle at a high speed, even if a part of the lock pin 11 enters the lock slot 22, the lock pin 11 can be pushed out of the lock slot 22 by means of the sliding fit between the chamfer 111 and the edge of the second limiting face 222, further reducing the risk of sharp stop of the rear wheel by accidentally inserting the lock pin 11 into the lock slot 22.

As illustrated in FIGS. 1 to 6, the chamfer 111 of the lock pin 11 is straight. Alternatively, the present embodiment may also set the chamfer 111 of the lock pin 11 to be rounded.

In some embodiments, the lock body 1 further comprises a lock case 12, an elastic member 13 and a fastener 14, the lock pin 11 is movably connected to the lock case 12 along the first direction, the elastic member 13 is connected to the lock case 12 and the lock pin 11, the elastic member 13 presses the lock pin 11 towards the first critical position, and the fastener 14 fastens the lock pin 11 and the lock case 12 at the second critical position.

When the vehicle does not need to be locked, the fastener 14 fastens the lock pin 11 at the second critical position, and in this case the elastic member 13 is in a compressed state. When the vehicle needs to be locked, the fastener 14 unlock the lock pin 11, the lock pin 11 moves towards the first critical position under springback of the elastic member 13, and until the lock slot 22 is opposite the lock pin 11, the lock pin 11 is inserted into the lock slot 22.

Specifically, the lock body 1 may be an electronic lock, i.e., further including a drive device. The driving device can drive the fastener 14 to unlock or lock the lock pin 11, and also can drive the lock pin 11 to move from the first critical position to the second critical position.

In some embodiments, as illustrated in FIG. 5, the hub 4 includes a motor chassis and a brake disc 41, the lock disc 2 is an annular disc, and the lock disc 2 is connected to the motor chassis or the brake disc 41 through a threaded member; and/or, the lock body 1 is connected to the rear fork 3 through a threaded member.

That is, the lock body 1 is detachably connected to the rear fork 3, and the lock disc 2 is detachably connected to the motor chassis or the brake disc 41, thus facilitating the disassembly and replacement of the lock body 1 and the lock disc 2. Furthermore, the lock disc 2 is set to be the annular disc, thus the volume and weight of the lock disc 2 are further reduced, and the cost of the hub lock is lower.

As illustrated in FIG. 6, a personal mobility vehicle 100 according to embodiments of the present disclosure includes the hub lock of any of the above embodiments.

The technical advantages of the personal mobility vehicle according to embodiments of the present disclosure are the same as those of the hub lock of the above embodiments and will not be repeated herein.

The personal mobility vehicle includes, but is not limited to, an electric bicycle and an electric scooter.

The hub lock according to embodiments of the present disclosure includes a lock body and a lock disc. The lock body is fixedly mounted to a rear fork and including a lock pin movable in a first direction, the lock pin has a first critical position and a second critical position. The lock disc is connected to a hub, the lock disc is provided with a lock slot and a guiding face capable of opposing the lock pin in the first direction, the lock pin is fitted in the lock slot at the first critical position, the lock pin is slidingly fitted to the guiding face during a movement from the second critical position towards the first critical position, the lock slot has a first limiting face and a second limiting face opposite each other along a circumferential direction of the hub, the first limiting face and the second limiting face are both joined to the guiding face, a size of the first limiting face in a depth direction of the lock slot is greater than a size of the second limiting face in the depth direction of the lock slot.

According to the hub lock of embodiments of the present disclosure, the lock body and the lock disc are mounted on the rear fork and the hub, respectively, and as the hub rotates, the lock slot on the lock disc rotates to oppose the lock pin, the lock pin can move to the first critical position to fit in the lock slot, and the relative fixation of the rear fork and the hub in the circumferential direction of the hub is realized under the limitation of the first limiting face and the second limiting face of the lock slot, i.e., realizing the locking function. The lock pin is accidentally ejected from the second critical position and moves towards the first critical position, the lock pin is more likely to abut against the guiding face and slidingly fit to the guiding face, and during this fitting, and there is no circumferential limitation on the hub.

In addition, the first limiting face of the lock slot is arranged to approach to the lock pin earlier relative to the second limiting face when the hub rotates at a high speed, and then the size of the first limiting face in the depth direction of the lock slot is arranged to be larger than the size of the second limiting face in the depth direction of the lock slot, so that when the lock slot is opposite to the lock pin, the lock pin can easily pass through the lock slot and continue to be slidingly fitted to the guiding face before it comes into contact with an outer edge of the second limiting face, which effectively reduces the risk of sharp stop of the rear wheel by inserting accidentally ejected lock pin into the lock slot, and makes the driving safety of the driver higher.

In some embodiments, a plurality of lock slots are provided and arranged at intervals along a circumferential direction of the hub lock, the guiding face includes a plurality of guiding sub-faces, the plurality of lock slots and the plurality of guiding sub-faces are arranged alternately along the circumferential direction of the hub.

In some embodiments, any of the guiding sub-faces has a first end and a second end opposite each other along the circumferential direction of the hub, a first end face of the guiding sub-face is joined to the first limiting face of the lock slot, and a second end face of the guiding sub-face is joined to the second limiting face of the lock slot; and
a distance between any position of the guiding sub-face from the first end to the second end of the guiding sub-face and a central axis of the hub decreases gradually.

In some embodiments, the guiding sub-face is a gradient surface curved toward the lock pin.

In some embodiments, the lock pin is located at a side of the lock disc along a radial direction of the hub, the lock slot is defined in an outer circumferential face of the lock disc, and at least a part of the outer circumferential face of the lock disc forms the guiding sub-face.

In some embodiments, the lock slot extends through the lock disc along an axial direction of the hub.

In some embodiments, a chamfer is provided at a junction of an outer circumferential face and a free end face of the lock pin.

In some embodiments, the lock body further includes a lock case, an elastic member and a fastener, the lock pin is movably connected to the lock case along the first direction, the elastic member is connected to the lock case and the lock pin, the elastic member presses the lock pin towards the first critical position, and the fastener fastens the lock pin and the lock case at the second critical position.

In some embodiments, the hub includes a motor chassis and a brake disc, the lock disc is an annular disc, and the lock disc is connected to the motor chassis or the brake disc through a threaded member; and/or, the lock body is connected to the rear fork through a threaded member.

A personal mobility vehicle according to embodiments of the present disclosure includes a hub lock as described in any of the above embodiments.

In the specification, it is to be understood that terms such as “central,” “longitudinal,” “lateral,” “length,” “width,” “thickness,” “upper,” “lower,” “front,” “rear,” “left,” “right,” “vertical,” “horizontal,” “top,” “bottom,” “inner,” “outer,” “clockwise,” “counterclockwise,” “axial,” “radial” and “circumferential” should be construed to refer to the orientation as then described or as shown in the drawings under discussion. These relative terms are for convenience of description and do not require that the present disclosure be constructed or operated in a particular orientation.

In addition, terms such as “first” and “second” are used herein for purposes of description and are not intended to indicate or imply relative importance or significance. Thus, the feature defined with “first” and “second” may comprise one or more of this feature. In the description of the present disclosure, “a plurality of” means at least two, e.g., two, three or like, unless specified otherwise.

In the present disclosure, unless specified or limited otherwise, the terms “mounted,” “connected,” “connected,” “fixed” and the like are used broadly, and may be, for example, fixed connections, detachable connections, or integral connections; may also be mechanical or electrical connections; may also be direct connections or indirect connections via intervening structures; may also be inner communications of two elements, unless limited otherwise. These having ordinary skills in the art should understand the specific meanings in the present disclosure according to specific situations.

In the present disclosure, unless specified or limited otherwise, a structure in which a first feature is “on” or “below” a second feature may include an embodiment in which the first feature is in direct contact with the second feature, and may also include an embodiment in which the first feature and the second feature are not in direct contact with each other, but are contacted via an additional feature formed therebetween. Furthermore, a first feature “on,” “above,” or “on top of” a second feature may include an embodiment in which the first feature is right or obliquely “on,” “above,” or “on top of” the second feature, or just means that the first feature is at a height higher than that of the second feature. While a first feature “below,” “under,” or “on bottom of” a second feature may include an embodiment in which the first feature is right or obliquely “below,” “under,” or “on bottom of” the second feature, or just means that the first feature is at a height lower than that of the second feature.

Reference throughout the present disclosure to “an embodiment,” “some embodiments,” “an example,” “a specific example,” or “some examples,” means that a particular feature, structure, material, or characteristic described in connection with the embodiment or example is included in at least one embodiment or example of the present disclosure. In the present specification, the appearances of the phrases in various places throughout this specification are not necessarily referring to the same embodiment or example of the present disclosure. Furthermore, the particular features, structures, materials, or characteristics may be combined in any suitable manner in one or more embodiments or examples. In addition, without conflicting, various embodiments or examples or features of various embodiments or examples described in the present specification may be combined by those skilled in the art.

Although the above embodiments have been shown and described, it would be appreciated by those skilled in the art that the above embodiments are explanatory, and cannot be construed to limit the present disclosure, and changes, modifications, alternatives, and variations can be made in the embodiments within the scope of the present disclosure.

1. A hub lock, comprising:
a lock body, the lock body being fixedly mounted to a rear fork and comprising a lock pin movable in a first direction between a first critical position and a second critical position; and
a lock disc, the lock disc being connected to a hub, the lock disc being provided with a lock slot and a guiding face capable of opposing the lock pin in the first direction, the lock pin being fitted in the lock slot at the first critical position, the lock pin being slidingly fitted to the guiding face during a movement from the second critical position towards the first critical position, the lock slot having a first limiting face and a second limiting face opposite each other along a circumferential direction of the hub, the first limiting face and the second limiting face being both joined to the guiding face, a size of the first limiting face in a depth direction of the lock slot being greater than a size of the second limiting face in the depth direction of the lock slot.

2. The hub lock according to claim 1, wherein a plurality of lock slots are provided and arranged at intervals along a circumferential direction of the hub lock, the guiding face comprises a plurality of guiding sub-faces, the plurality of lock slots and the plurality of guiding sub-faces are arranged alternately along the circumferential direction of the hub.

3. The hub lock according to claim 2, wherein each of the guiding sub-faces has a first end and a second end opposite each other along the circumferential direction of the hub, a first end face of the guiding sub-face is joined to the first limiting face of the lock slot, and a second end face of the guiding sub-face is joined to the second limiting face of the lock slot; and
a distance between any position of the guiding sub-face from the first end to the second end of the guiding sub-face and a central axis of the hub decreases gradually.

4. The hub lock according to claim 2, wherein the guiding sub-face is a gradient surface curved towards the lock pin.

5. The hub lock according to claim 2, wherein the lock pin is located at a side of the lock disc along a radial direction of the hub, the lock slot is defined in an outer circumferential face of the lock disc, and at least a part of the outer circumferential face of the lock disc forms the guiding sub-face.

6. The hub lock according to claim 5, wherein the lock slot extends through the lock disc along an axial direction of the hub.

7. The hub lock according to claim 1, wherein a chamfer is provided at a junction of an outer circumferential face and a free end face of the lock pin.

8. The hub lock according to claim 1, wherein the lock body further comprises a lock case, an elastic member and a fastener, the lock pin is movably connected to the lock case along the first direction, the elastic member is connected to the lock case and the lock pin, the elastic member presses the lock pin towards the first critical position, and the fastener fastens the lock pin and the lock case at the second critical position.

9. The hub lock according to claim 1, wherein the hub comprises a motor chassis and a brake disc, the lock disc is an annular disc, and the lock disc is connected to the motor chassis or the brake disc through a threaded member.

10. The hub lock according to claim 1, wherein the lock body is connected to the rear fork through a threaded member.

11. A personal mobility vehicle comprising:
a hub lock, comprising:
a lock body, the lock body being fixedly mounted to a rear fork and comprising a lock pin movable in a first direction, the lock pin having a first critical position and a second critical position; and
a lock disc, the lock disc being connected to a hub, the lock disc being provided with a lock slot and a guiding face capable of opposing the lock pin in the first direction, the lock pin being fitted in the lock slot at the first critical position, the lock pin being slidingly fitted to the guiding face during a movement from the second critical position towards the first critical position, the lock slot having a first limiting face and a second limiting face opposite each other along a circumferential direction of the hub, the first limiting face and the second limiting face being both joined to the guiding face, a size of the first limiting face in a depth direction of the lock slot being greater than a size of the second limiting face in the depth direction of the lock slot.

12. The personal mobility vehicle according to claim 11, wherein a plurality of lock slots are provided and arranged at intervals along a circumferential direction of the hub lock, the guiding face comprises a plurality of guiding sub-faces, the plurality of lock slots and the plurality of guiding sub-faces are arranged alternately along the circumferential direction of the hub.

13. The personal mobility vehicle according to claim 12, wherein each of the guiding sub-faces has a first end and a second end opposite each other along the circumferential direction of the hub, a first end face of the guiding sub-face is joined to the first limiting face of the lock slot, and a second end face of the guiding sub-face is joined to the second limiting face of the lock slot; and
a distance between any position of the guiding sub-face from the first end to the second end of the guiding sub-face and a central axis of the hub decreases gradually.

14. The personal mobility vehicle according to claim 12, wherein the guiding sub-face is a gradient surface curved towards the lock pin.

15. The personal mobility vehicle according to claim 12, wherein the lock pin is located at a side of the lock disc along a radial direction of the hub, the lock slot is defined in an outer circumferential face of the lock disc, and at least a part of the outer circumferential face of the lock disc forms the guiding sub-face.

16. The personal mobility vehicle according to claim 15, wherein the lock slot extends through the lock disc along an axial direction of the hub.

17. The personal mobility vehicle according to claim 11, wherein a chamfer is provided at a junction of an outer circumferential face and a free end face of the lock pin.

18. The personal mobility vehicle according to claim 11, wherein the lock body further comprises a lock case, an elastic member and a fastener, the lock pin is movably connected to the lock case along the first direction, the clastic member is connected to the lock case and the lock pin, the elastic member presses the lock pin towards the first critical position, and the fastener fastens the lock pin and the lock case at the second critical position.

19. The personal mobility vehicle according to claim 1, wherein the hub comprises a motor chassis and a brake disc, the lock disc is an annular disc, and the lock disc is connected to the motor chassis or the brake disc through a threaded member.

20. The personal mobility vehicle according to claim 11, wherein the lock body is connected to the rear fork through a threaded member.
